(19) United States
(12) Patent Application Publication
(10) Pub. No.: US 2026/0331495 A1
(43) Pub. Date: Oct. 22, 2026

(54) BATTERY AND METHOD FOR MANUFACTURING BATTERY

(71) Applicant: SEMICONDUCTOR ENERGY LABORATORY CO., LTD., Atsugi-shi, Kanagawa-ken (JP)

(72) Inventors: Kengo AKIMOTO, Isehara, Kanagawa (JP); Kazutaka KURIKI, Ebina, Kanagawa (JP); Teruaki OCHIAI, Atsugi, Kanagawa (JP)

(21) Appl. No.: 19/109,740

(22) PCT Filed: Oct. 16, 2023
(86) PCT No.: PCT/IB2023/060396

§ 371 Date: Mar. 7, 2025

(30) Foreign Application Priority Data
Oct. 21, 2022 (JP) 2022-168996

(51) Int. Cl. H01M 4/583; H01M 4/04; H01M 4/36; H01M 4/38; H01M 10/0525; H01M 50/414

(52) U.S. Cl. CPC H01M 4/583; H01M 4/0416; H01M 4/0426; H01M 4/366; H01M 4/386; H01M 10/0525; H01M 50/414

(57) ABSTRACT

A lightweight battery is provided. The battery includes a separator-integrated electrode in which a separator and an electrode are integrated with each other, and the separator-integrated electrode includes the separator, a carbon particle layer, and a silicon layer positioned between the separator and the carbon particle layer. The silicon layer can be formed by a sputtering method, and the carbon particle layer can be formed by a coating method. Preferably, the separator includes polypropylene, the thickness of the silicon layer is greater than or equal to 100 nm and less than or equal to 200 nm, and the carbon particle layer includes graphite particles.

### TECHNICAL FIELD

One embodiment of the present invention relates to a power storage device (also referred to as a battery or a secondary battery). The present invention is not limited to the above field and relates to a semiconductor device, a display device, a light-emitting device, a lighting device, an electronic device, a vehicle, and manufacturing methods thereof. A battery of the present invention can be used as a power source necessary for the above semiconductor device, display device, light-emitting device, lighting device, electronic device, and vehicle. Examples of the battery include secondary batteries such as a lithium-ion battery and a sodium-ion battery. Examples of the above electronic device include an information terminal device provided with a lithium-ion battery. Examples of the above power storage device include a stationary power storage device.

### BACKGROUND ART

In recent years, a variety of storage batteries such as lithium-ion batteries, lithium-ion capacitors, air batteries, and all-solid-state batteries have been actively developed. In particular, demand for lithium-ion batteries with high output and high capacity has rapidly grown with the development of the semiconductor industry. The lithium-ion batteries are essential as rechargeable energy supply sources for today's information society.

In this manner, lithium-ion batteries have been used for a variety of purposes in various fields. Examples of performance required for lithium-ion batteries under such circumstances include a high energy density per unit weight, a high energy density per unit volume, excellent cycle performance, and safety in a variety of operation environments, and development has been actively conducted in terms of various aspects.

For example, Patent Document 1 has studied an electrode structure of a lithium-ion battery.

### REFERENCE

### Patent Document

[Patent Document 1] Japanese Published Patent Application No. 2015-109270

### SUMMARY OF THE INVENTION

### Problems to be Solved by the Invention

Lithium-ion batteries have been required to be lightweight and small, for example. Meanwhile, lithium-ion batteries are required to have high dischargeable capacity at the same time. Thus, the weight and size of lithium-ion batteries have been reduced by thinning a current collector (metal foil having a thickness of approximately 10 μm is used), a separator, and an exterior body, which do not contribute to the discharge capacity among components of the lithium-ion batteries.

Patent Document 1 discloses a battery structure that does not include metal foil as a current collector and a manufacturing method thereof. However, there is room for improvement in the battery structure and the manufacturing method thereof.

An object is to provide a lightweight battery by one embodiment of the present invention. Another object is to provide a method for manufacturing a lightweight battery. Another object is to provide a lightweight electrode by one embodiment of the present invention. Another object is to provide a method for manufacturing a lightweight electrode. Another object is to provide a small battery by one embodiment of the present invention. Another object is to provide a method for manufacturing a small battery. Another object is to provide a small electrode by one embodiment of the present invention. Another object is to provide a method for manufacturing a small electrode.

Another object is to provide a battery structure in which at least one of a positive electrode and a negative electrode does not include metal foil as a current collector by one embodiment of the present invention. Another object is to provide a method for manufacturing a battery in which at least one of a positive electrode and a negative electrode does not include metal foil as a current collector.

Another object is to provide a battery structure in which copper foil is not included as a current collector by one embodiment of the present invention. Another object is to provide a method for manufacturing a battery that does not include copper foil as a current collector. Another object is to prevent dissolution of copper ions into an electrolyte solution in an overdischarge state by making a battery not include copper foil as a current collector.

Another object of one embodiment of the present invention is to provide a novel electrode, a novel battery, or manufacturing methods thereof.

Note that the description of these objects does not preclude the existence of other objects. One embodiment of the present invention does not necessarily achieve all these objects. Other objects can be derived from the description of the specification, the drawings, and the claims.

### Means for Solving the Problems

One embodiment of the present invention is a battery including a separator-integrated electrode. The separator-integrated electrode includes a separator, a carbon particle layer, and a silicon layer positioned between the separator and the carbon particle layer.

One embodiment of the present invention is a battery including a separator-integrated electrode and an exterior body. The separator-integrated electrode includes a separator, a carbon particle layer, and a silicon layer positioned between the separator and the carbon particle layer. The carbon particle layer and the exterior body include a region where they are in contact with each other.

In the above, the thickness of the silicon layer is preferably greater than or equal to 100 nm and less than or equal to 200 nm.

In the above, the separator preferably includes polypropylene.

Another embodiment of the present invention is a method for manufacturing a battery including a separator-integrated electrode including a separator, a carbon particle layer, and a silicon layer positioned between the separator and the carbon particle layer, which includes a first step of forming the silicon layer over the separator by a sputtering method; and a second step of forming the carbon particle layer over the silicon layer by application of slurry including carbon particles. The thickness of the silicon layer is greater than or equal to 100 nm and less than or equal to 200 nm.

In the above, the slurry preferably includes N-methyl-pyrrolidone.

In the above, the separator preferably includes polypropylene.

### Effect of the Invention

According to one embodiment of the present invention, a lightweight battery can be provided. Alternatively, a method for manufacturing a lightweight battery can be provided. According to another embodiment of the present invention, a lightweight electrode can be provided. Alternatively, a method for manufacturing a lightweight electrode can be provided. According to another embodiment of the present invention, a small battery can be provided. Alternatively, a method for manufacturing a small battery can be provided. According to another embodiment of the present invention, a small electrode can be provided. Alternatively, a method for manufacturing a small electrode can be provided.

According to another embodiment of the present invention, it is possible to provide a battery structure in which at least one of a positive electrode and a negative electrode does not include metal foil as a current collector. Alternatively, it is possible to provide a method for manufacturing a battery in which at least one of a positive electrode and a negative electrode does not include metal foil as a current collector.

According to another embodiment of the present invention, it is possible to provide a battery structure in which copper foil is not included as a current collector. Alternatively, it is possible to provide a method for manufacturing a battery that does not include copper foil as a current collector. Alternatively, it is possible to prevent dissolution of copper ions into an electrolyte solution in an overdischarge state by making a battery not include copper foil as a current collector.

According to another embodiment of the present invention, a novel electrode, a novel battery, or manufacturing methods thereof can be provided.

Note that the description of these effects does not preclude the existence of other effects. One embodiment of the present invention does not need to have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1D are diagrams illustrating a manufacturing method and a structure of a separator-integrated electrode.

FIG. 2A to FIG. 2C are diagrams illustrating structures of a battery including a separator-integrated electrode.

FIG. 3A to FIG. 3C are diagrams illustrating variation examples of a structure of a separator-integrated electrode.

FIG. 4A illustrates an example of a cylindrical secondary battery. FIG. 4B illustrates an example of a cylindrical secondary battery. FIG. 4C illustrates an example of a plurality of cylindrical secondary batteries. FIG. 4D illustrates an example of a power storage system including a plurality of cylindrical secondary batteries.

FIG. 5A and FIG. 5B are diagrams illustrating examples of a secondary battery, and FIG. 5C is a diagram illustrating the internal state of a secondary battery.

FIG. 6A to FIG. 6C are diagrams illustrating an example of a secondary battery.

FIG. 7A and FIG. 7B are external views of a secondary battery.

FIG. 8A to FIG. 8C are diagrams illustrating a method for manufacturing a secondary battery.

FIG. 9A illustrates a structure example of a battery pack, FIG. 9B illustrates a structure example of the battery pack, and FIG. 9C illustrates a structure example of the battery pack.

FIG. 10A is a perspective view of a battery pack of one embodiment of the present invention, FIG. 10B is a block diagram of the battery pack, and FIG. 10C is a block diagram of a vehicle including the battery pack.

FIG. 11A to FIG. 11D are diagrams illustrating examples of transport vehicles. FIG. 11E is a diagram illustrating an example of an artificial satellite.

FIG. 12A and FIG. 12B are diagrams each illustrating a power storage device of one embodiment of the present invention.

FIG. 13A is a diagram illustrating an electric bicycle, FIG. 13B is a diagram illustrating a secondary battery of the electric bicycle, and FIG. 13C is a diagram illustrating a motor scooter.

FIG. 14A to FIG. 14D are diagrams illustrating examples of electronic devices.

FIG. 15A illustrates examples of wearable devices, FIG. 15B is a perspective view of a watch-type device, and FIG. 15C is a diagram illustrating a side surface of the watch-type device.

FIG. 16A to FIG. 16D are SEM images described in Example 1.

FIG. 17A to FIG. 17C are graphs of charge and discharge performance described in Example 1.

### MODE FOR CARRYING OUT THE INVENTION

Examples of embodiments of the present invention will be described below with reference to the drawings and the like. Note that the present invention should not be interpreted as being limited to the examples of the embodiments given below. Embodiments of the invention can be changed unless they deviate from the spirit of the present invention.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

Note that components illustrated in drawings and the like in the embodiments are sometimes exaggerated for clarity. It is therefore noted that each component is not necessarily limited to the illustrated scale.

### Embodiment 1

One embodiment of the present invention has a structure in which a separator and an electrode are integrated with each other. This structure may be referred to as an electrode integrated with a separator. This embodiment will describe a structure and a manufacturing method of an electrode integrated with a separator. In this specification, an electrode integrated with a separator is referred to as a separator-integrated electrode.

One embodiment of the present invention features an electrode structure where metal foil is not included as a current collector.

Alternatively, one embodiment of the present invention features an electrode structure where copper foil is not included as a current collector.

Note that the electrode described in this embodiment can be used as a positive electrode or a negative electrode of a battery. For example, in a battery using the electrode as one of a positive electrode and a negative electrode, the electrode when having a higher reaction potential than the other electrode is referred to as a positive electrode. For another example, in a battery using the electrode as one of a positive electrode and a negative electrode, the electrode when having a lower reaction potential than the other electrode is referred to as a negative electrode.

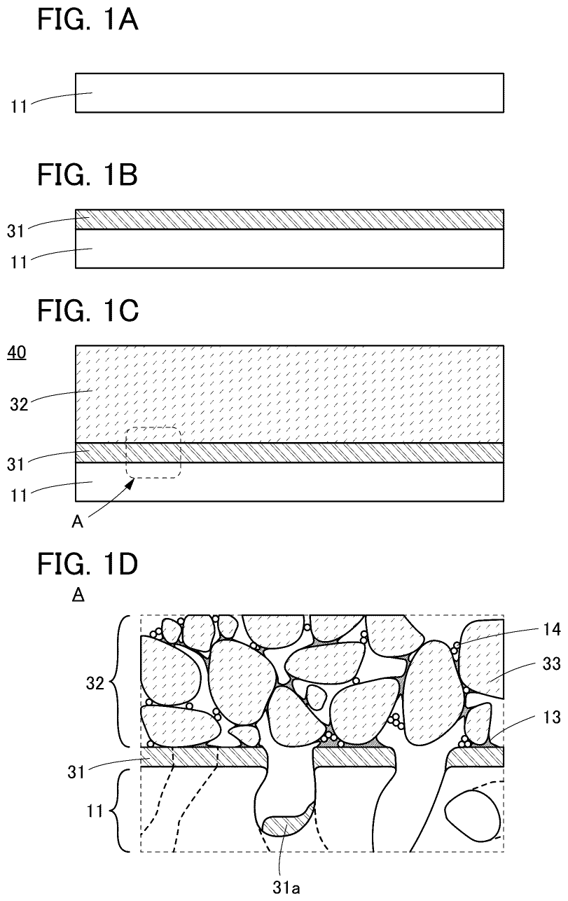

A structure and a manufacturing method of an electrode of one embodiment of the present invention will be described with reference to FIG. 1A to FIG. 1D.

FIG. 1A to FIG. 1C are cross-sectional views illustrating a method for manufacturing a separator-integrated electrode. FIG. 1D is an enlarged view of a region A indicated by a dashed line in FIG. 1C.

A method for manufacturing the separator-integrated electrode is described. First, a separator 11 is prepared as illustrated in FIG. 1A.

For the separator 11, it is possible to use, for example, fiber containing cellulose, such as paper, nonwoven fabric, glass fiber, ceramics, or a porous film using nylon (polyamide), polyimide, vinylon (polyvinyl alcohol-based fiber), polyester, acrylic, polyolefin, or polyurethane. As a porous film using polyolefin, a porous polypropylene film can be used, for example.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles (e.g., alumina and boehmite) and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging can be inhibited and the reliability of the battery can be improved. When the separator is coated with the fluorine-based material, the separator is easily brought into close contact with an electrode, resulting in high output performance. When the separator is coated with the polyamide-based material, in particular, aramid, the heat resistance is improved; thus, the safety of the battery can be improved.

Accordingly, in a structure where one surface of the separator is subjected to the above-described coating and the other surface is integrated with an electrode, the electrode that is integrated with the separator is preferably a negative electrode.

With the use of a separator having a multilayer structure, the capacity per volume of the battery can be increased because the safety of the battery can be maintained even when the total thickness of the separator is small.

Next, as illustrated in FIG. 1B, a silicon layer 31 is formed over the separator 11. The silicon layer 31 can be formed by a sputtering method. As a silicon deposition method, a CVD method, a vacuum evaporation method, a PLD method, or the like may alternatively be used. The thickness of the silicon layer 31 is preferably greater than or equal to 50 nm and less than or equal to 1000 nm, further preferably greater than or equal to 100 nm and less than or equal to 200 nm. In the case where the thickness of the silicon layer 31 is smaller than 50 nm, a slurry solvent or the like might pass through a cavity (e.g., a pinhole) of the silicon layer 31 in the formation of a carbon particle layer 32 provided over the silicon layer 31, and as a result, the separator 11 might be dissolved by the solvent and the silicon layer 31 might peel off. In the case where the thickness is greater than 1000 nm, the resistance of the silicon layer 31 is increased and the battery performance might be decreased. With such a silicon layer 31, adhesion between the separator 11 and a coating electrode layer described later can be improved. Note that the thickness of the separator 11 is preferably greater than or equal to 5 μm, further preferably greater than or equal to 10 μm in order that the shape of the separator 11 is prevented from being largely changed by film stress of the silicon layer 31.

Then, as illustrated in FIG. 1C, the carbon particle layer 32 is formed over the silicon layer 31. The carbon particle layer 32 can be formed in the following manner, for example: slurry including graphite particles is applied onto the silicon layer 31 by a blade coating apparatus or the like, and a solvent contained in the slurry including graphite particles is dried by a drying furnace or the like. The carbon particle layer 32 is therefore referred to as a graphite layer, a graphite particle layer, or a coating electrode layer in some cases. As a method for applying slurry, a slot die coater, a lip coater, a reverse coater, a gravure coater, or the like can also be used.

Note that the thickness of the carbon particle layer 32 is preferably greater than or equal to 5 μm and less than or equal to 200 μm, further preferably greater than or equal to 10 μm and less than or equal to 100 μm.

In this manner, a separator-integrated electrode 40 in which the separator and the electrode are integrated with each other can be fabricated.

The structure of the separator-integrated electrode 40 is described with reference to FIG. 1D. The separator-integrated electrode 40 includes the separator 11, the silicon layer 31, and the carbon particle layer 32.

The separator 11 has a function of separating the positive electrode and the negative electrode from each other and a function of transmitting an electrolyte solution in a lithium-ion battery. Accordingly, the separator 11 has a large number of pores as illustrated in FIG. 1D.

As illustrated in FIG. 1D, the silicon layer 31 is formed on the top surface of the separator 11. Note that like a silicon layer 31a in the drawing, part of the silicon layer 31 may be formed inside a pore included in the separator 11. The silicon layer 31 may include silicon oxide in its surface portion.

The carbon particle layer 32 is formed to be in contact with the top surface of the silicon layer 31. The carbon particle layer 32 includes carbon particles 33 and a binder 13. Note that the carbon particle layer 32 may include a conductive material 14.

For the carbon particles 33, graphite (natural graphite or artificial graphite), graphitizing carbon (soft carbon), non-graphitizing carbon (hard carbon), or the like can be used, for example.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Non-graphitizing carbon can be obtained by baking a synthetic resin such as a phenol resin or an organic substance of plant origin, for example. In non-graphitizing carbon contained in a negative electrode active material of a lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the binder 13, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, water-soluble polymers are preferably used, for example. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

As the binder, two or more of the above materials may be used in combination.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the fabrication of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to suppress the decomposition of the electrolyte solution. Here, the “passivation film” refers to a film without electrical conductivity or a film with extremely low electrical conductivity; for example, a passivation film formed on the active material surface can inhibit the decomposition of an electrolyte solution at a battery reaction potential. It is desirable that the passivation film can conduct lithium ions while suppressing electrical conduction.

For the conductive material 14, it is possible to use, for example, one kind or two or more kinds of carbon black such as acetylene black and furnace black, graphite such as artificial graphite and natural graphite, carbon fiber such as carbon nanofiber and carbon nanotube, and a graphene compound.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method.

The content of the conductive material to the total volume of the active material layer is preferably greater than or equal to 0.5 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed.

As illustrated in FIG. 1D, the separator 11 and the carbon particle layer 32 included in the separator-integrated electrode 40 are integrated with each other with the silicon layer 31 therebetween.

As described above, the separator-integrated electrode 40 does not include metal foil. The separator-integrated electrode 40 can be formed without using metal foil. That is, a battery using the separator-integrated electrode 40 can be lightweight. Moreover, the battery using the separator-integrated electrode 40 can be downsized. In the case where the separator-integrated electrode 40 is used as a negative electrode, metal foil, particularly copper foil, is not included; thus, dissolution of copper ions from copper foil into the electrolyte solution does not occur in an overdischarge state, resulting in a safe battery.

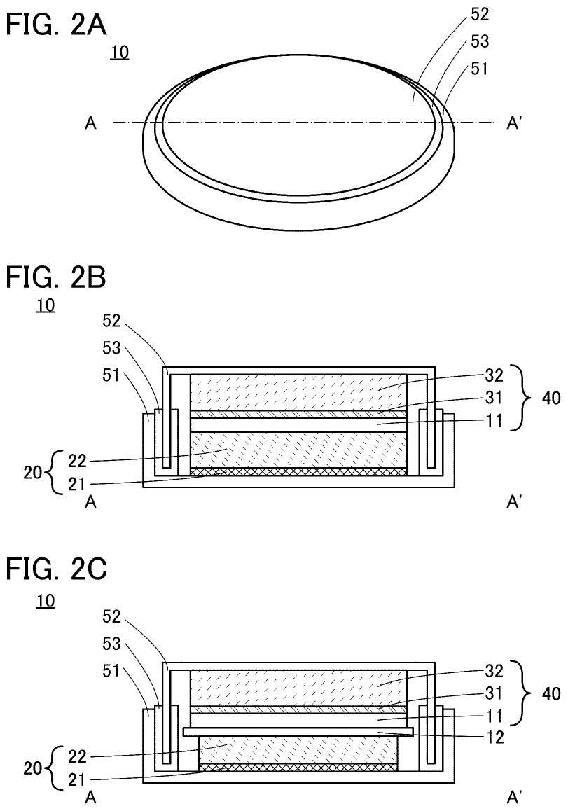

FIG. 2A to FIG. 2C are diagrams illustrating a coin-type battery and illustrate examples in which the separator-integrated electrode 40 is used as a negative electrode.

FIG. 2A is a perspective view of a coin-type battery. FIG. 2B is a cross-sectional view along the dashed-dotted line A-A′ in FIG. 2A. FIG. 2C illustrates a variation example of FIG. 2B.

As illustrated in FIG. 2A and FIG. 2B, a coin-type battery 10 includes a positive electrode can 51, a negative electrode can 52, and a gasket 53, and the positive electrode can 51 and the negative electrode can 52 overlap each other with the gasket 53 therebetween. Note that the positive electrode can 51, the negative electrode can 52, and the gasket 53 are sometimes referred to as an exterior body.

As illustrated in FIG. 2B, in the coin-type battery 10, the positive electrode 20 and the separator-integrated electrode 40 are positioned inside the exterior body. Although not illustrated, an electrolyte is provided inside the exterior body.

The positive electrode 20 includes a positive electrode current collector 21 and a positive electrode active material layer 22 provided over the positive electrode current collector. The separator-integrated electrode 40 is as described above. The positive electrode 20 and the separator-integrated electrode 40 overlap each other such that the positive electrode active material layer 22 and the separator 11 included in the separator-integrated electrode 40 are in contact with each other.

The separator-integrated electrode 40 of one embodiment of the present invention does not include a current collector. Thus, in some cases, the carbon particle layer 32 included in the separator-integrated electrode 40 and the negative electrode can 52, which is the exterior body, include a region where they are in contact with each other.

As another structure example different from the structure example illustrated in FIG. 2B, a separator 12 may be provided between the positive electrode 20 and the separator-integrated electrode 40 as illustrated in FIG. 2C. The area of the separator-integrated electrode 40 may be larger than the area of the positive electrode 20 as illustrated in FIG. 2C.

As described above, the separator-integrated electrode 40 of one embodiment of the present invention can be an electrode having a structure not including a current collector. Thus, a battery including the separator-integrated electrode 40 achieves a battery structure in which at least one of the positive electrode and the negative electrode does not include a current collector. Accordingly, the battery including the separator-integrated electrode 40 achieves a lightweight battery structure. Alternatively, the battery including the separator-integrated electrode 40 achieves a small battery structure.

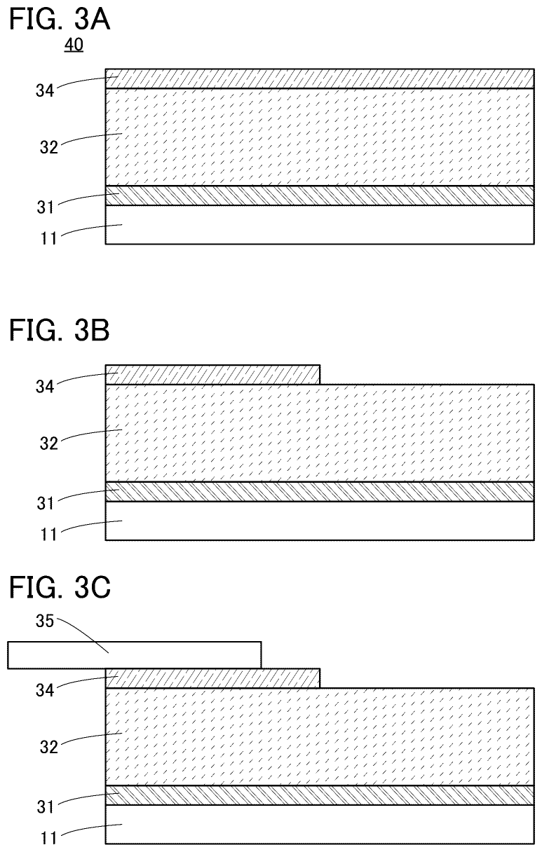

The separator-integrated electrode 40 of one embodiment of the present invention is not limited to having the structures illustrated in FIG. 1 and FIG. 2, and can include a metal layer 34 over the carbon particle layer 32 as illustrated in FIG. 3A. The metal layer 34 may be provided to cover the entire surface of the carbon particle layer 32, or may be provided to cover part of the carbon particle layer 32 as illustrated in FIG. 3B.

In the case where the battery including the separator-integrated electrode 40 is a battery having a shape different from the coin-type battery, for example, a laminated battery, a cylindrical battery, or a rectangular battery, the metal layer 34 may be connected to a lead 35 as illustrated in FIG. 3C.

The metal layer 34 is preferably formed by a gas phase method such as a sputtering method, an evaporation method, or a CVD method. The formation of the metal layer 34 by a gas phase method prevents the thickness of the metal layer 34 from becoming larger than necessary, and thus, the weight of the battery is easily reduced.

For the metal layer 34, it is possible to use one or more of Ti, Pb, Zn, Sn, Mg, Zr, In, Cu, Ni, and Li, for example. The thickness of the metal layer 34 can be greater than or equal to 10 nm and less than or equal to 20 μm, preferably greater than or equal to 10 nm and less than or equal to 10 μm, further preferably greater than or equal to 10 nm and less than or equal to 5 μm.

As described above, even when including the metal layer 34, the separator-integrated electrode 40 of one embodiment of the present invention can be an electrode having a structure not including metal foil as a current collector. Thus, a battery including the separator-integrated electrode 40 achieves a battery structure in which at least one of the positive electrode and the negative electrode does not include metal foil as a current collector. Accordingly, the battery including the separator-integrated electrode 40 achieves a lightweight battery structure. Alternatively, the battery including the separator-integrated electrode 40 achieves a small battery structure.

The structure, method, and the like described in this embodiment can be used in an appropriate combination with any of structures, methods, and the like described in the other embodiments.

### Embodiment 2

This embodiment will describe examples of the shape of a secondary battery including the separator-integrated electrode formed by the manufacturing method described in the foregoing embodiment as a negative electrode.

### [Cylindrical Secondary Battery]

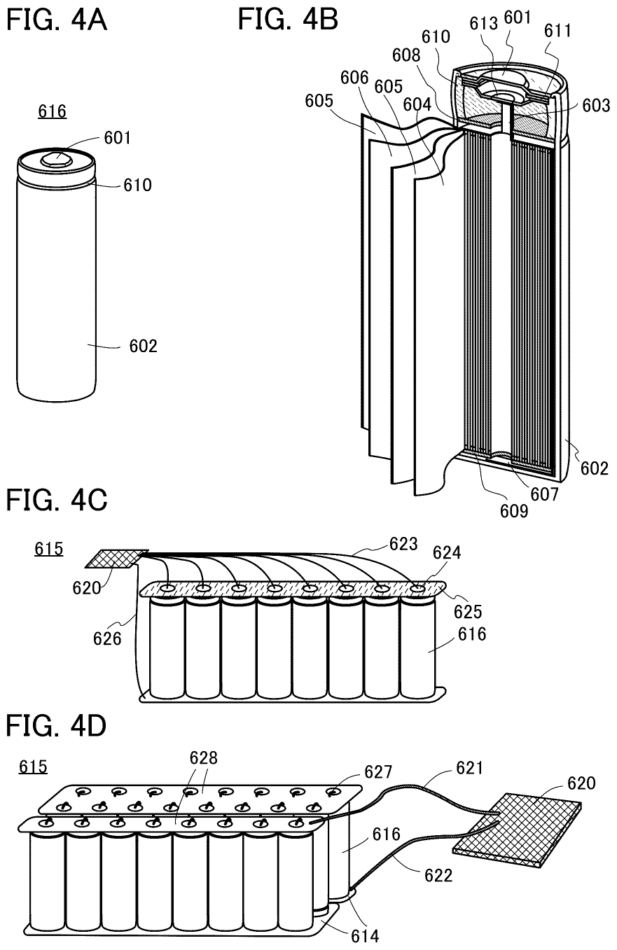

An example of a cylindrical secondary battery is described with reference to FIG. 4A. As illustrated in FIG. 4A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 4B is a diagram schematically illustrating a cross section of a cylindrical secondary battery. The cylindrical secondary battery illustrated in FIG. 4B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. In this manner, another separator may be further included in addition to the separator included in the separator-integrated electrode (negative electrode 606). Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that for the coin-type secondary battery can be used.

Since a positive electrode and a negative electrode that are used for a cylindrical storage battery are wound, active materials are preferably formed on both surfaces of a current collector.

Using the separator-integrated electrode described in Embodiment 1 as the negative electrode 606 enables the cylindrical secondary battery 616 to have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 4C illustrates an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 4D illustrates an example of the power storage system 615. The power storage system 615 includes a plurality of the secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 4D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

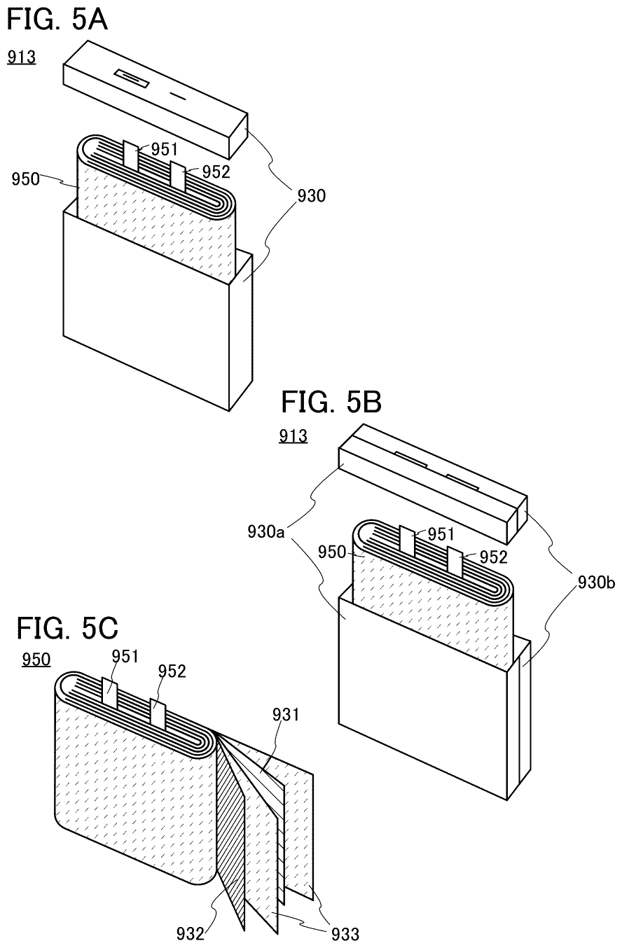

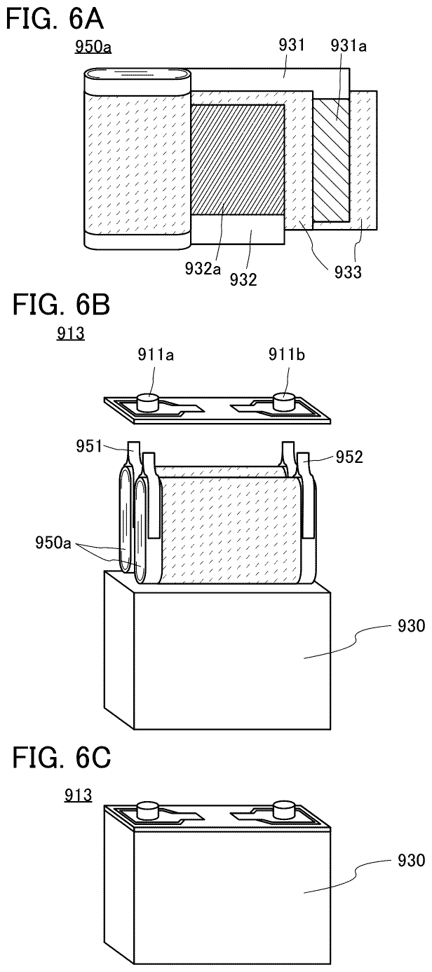

Other structure examples of a secondary battery including the separator-integrated electrode as the negative electrode will be described with reference to FIG. 5 and FIG. 6.

A secondary battery 913 illustrated in FIG. 5A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 5A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 5B, the housing 930 illustrated in FIG. 5A may be formed using a plurality of materials. For example, in the secondary battery 913 illustrated in FIG. 5B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 5C illustrates the structure of the wound body 950. The wound body 950 includes a negative electrode 931, a positive electrode 932, and separators 933. In this manner, separators different from the separator included in the separator-integrated electrode (negative electrode 931) may be included. The wound body 950 is obtained by winding a sheet of a stack in which the negative electrode 931 and the positive electrode 932 overlap each other with the separator 933 therebetween. Note that a plurality of stacks each including the negative electrode 931, the positive electrode 932, and the separators 933 may be further stacked.

The secondary battery 913 may include a wound body 950a illustrated in FIG. 6. The wound body 950a illustrated in FIG. 6A includes the negative electrode 931, the positive electrode 932, and the separators 933. The negative electrode 931 includes a negative electrode active material layer 931a. The positive electrode 932 includes a positive electrode active material layer 932a.

With the use of the separator-integrated electrode described in Embodiment 1, the secondary battery 913 can be lightweight. Alternatively, the secondary battery can be flexible.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 6B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 6C, the wound body 950a and an electrolyte solution are covered with the housing 930, whereby the secondary battery 913 is completed. The housing 930 is preferably provided with a safety valve, an overcurrent protection element, and the like. The safety valve is a valve to be released when the internal pressure of the housing 930 reaches a predetermined pressure, in order to prevent the battery from exploding.

As illustrated in FIG. 6B, the secondary battery 913 may include a plurality of the wound bodies 950a. The use of the plurality of wound bodies 950a enables the secondary battery 913 to have higher discharge capacity. The description of the secondary battery 913 illustrated in FIG. 5A to FIG. 5C can be referred to for the other components of the secondary battery 913 illustrated in FIG. 6A and FIG. 6B.

### <Laminated Secondary Battery>

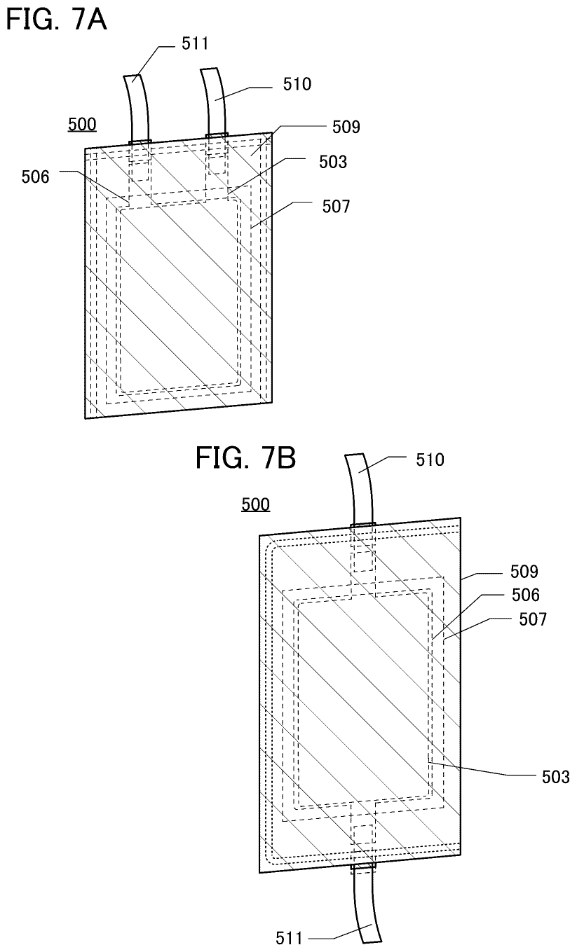

Next, FIG. 7A and FIG. 7B illustrate examples of the appearance of a laminated secondary battery including the separator-integrated electrode as a negative electrode. FIG. 7A and FIG. 7B each illustrate a positive electrode 503, a negative electrode 506, a separator 507, an exterior body 509, a positive electrode lead electrode 510, and a negative electrode lead electrode 511. In this manner, a separator different from the separator included in the separator-integrated electrode (negative electrode 506) may be included.

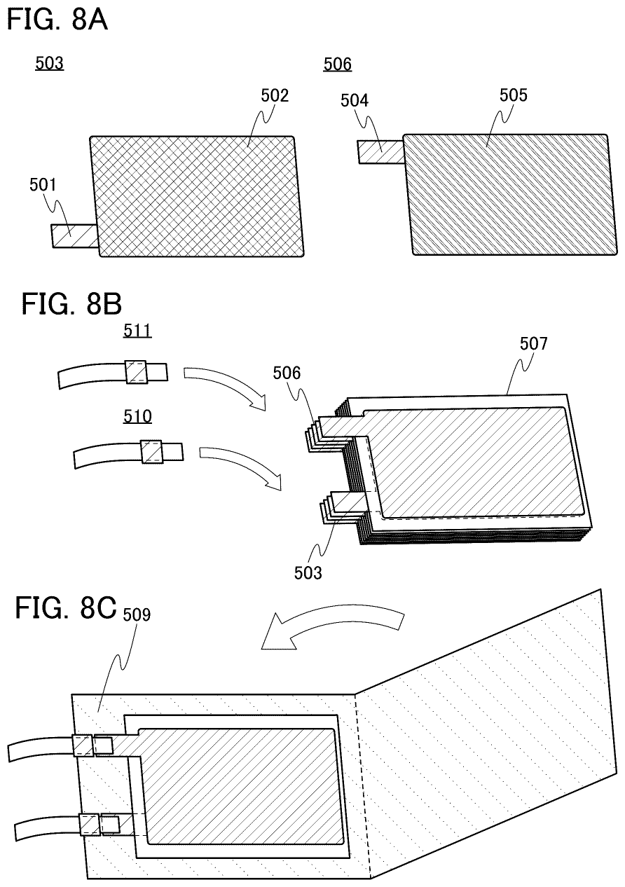

FIG. 8A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples shown in FIG. 8A.

### <Method for Manufacturing Laminated Secondary Battery>

An example of a method for manufacturing the laminated secondary battery having the appearance illustrated in FIG. 7A will be described with reference to FIG. 8B and FIG. 8C.

First, the negative electrode 506, the separator 507, and the positive electrode 503 are stacked. FIG. 8B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 8C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

With the use of the separator-integrated electrode described in Embodiment 1, the secondary battery 500 can be lightweight.

### [Examples of Battery Pack]

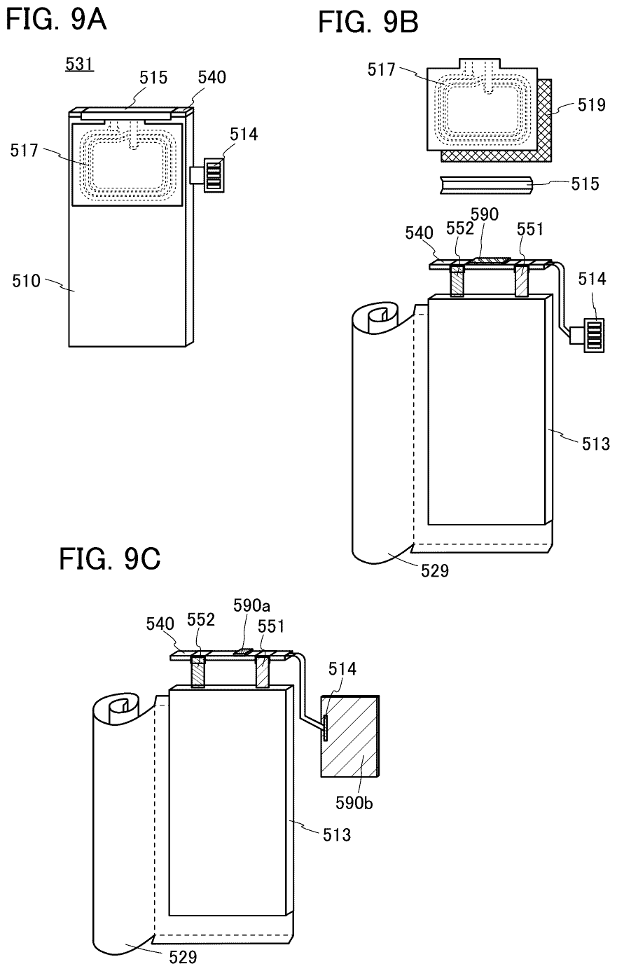

Examples of a secondary battery pack of one embodiment of the present invention that is capable of wireless charging using an antenna will be described with reference to FIG. 9.

FIG. 9A is a diagram illustrating the appearance of a secondary battery pack 531 that has a rectangular solid shape with a small thickness (also referred to as a flat plate shape with a certain thickness). FIG. 9B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 9B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 9C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. For the layer 519, a magnetic material can be used, for example.

The structure, method, and the like described in this embodiment can be used in an appropriate combination with any of structures, methods, and the like described in the other embodiments.

### Embodiment 3

In this embodiment, examples of vehicles each including a secondary battery of one embodiment of the present invention will be described.

The secondary battery can be used in vehicles, typically automobiles. Examples of automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. Vehicles are not limited to automobiles. Other examples of vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for such vehicles.

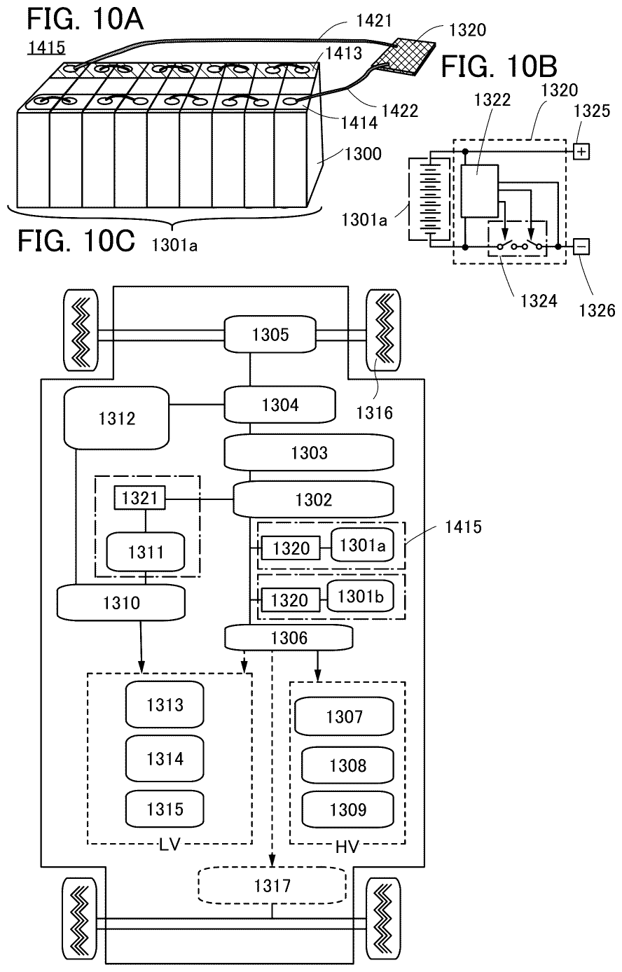

As illustrated in FIG. 10C, an electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output but does not necessarily have high capacity, and the capacity of the second battery 1311 is lower than that of the first batteries 1301a and 1301b.

The internal structure of the first battery 1301a may be the wound structure illustrated in FIG. 5C or FIG. 6A or the stacked-layer structure illustrated in FIG. 7A or FIG. 7B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (e.g., an electric power steering 1307, a heater 1308, and a defogger 1309) through a DCDC circuit 1306. In the case where there is a rear motor 1317 for rear wheels, the first battery 1301a is used to rotate the rear motor 1317.

The second battery 1311 supplies electric power to in-vehicle parts for 14 V (e.g., a stereo 1313, a power window 1314, and lamps 1315) through a DCDC circuit 1310.

Next, the first battery 1301a is described with reference to FIG. 10A.

FIG. 10A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). An In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the regions containing In as its main component (the first regions) and the regions containing Ga as its main component (the second regions) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, a high on-state current (Ion), high field-effect mobility (p), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40 °C to 150 °C, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150 °C independently of the temperature; meanwhile, the off-state current characteristics of the single crystal Si transistor largely depend on the temperature. For example, at 150 °C, the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause uneven distribution of positive electrode active materials, which leads to local concentration of current in part of the positive electrode and part of the negative electrode, whereby part of a separator stops functioning or a by-product is generated by a side reaction, which is thought to generate a micro short circuit.

It can be said that the control circuit portion 1320 not only detects a micro-short circuit but also senses the terminal voltage of the secondary battery and controls the charge and discharge state of the secondary battery. For example, to prevent overcharging, an output transistor of a charge circuit and an interruption switch can be turned off substantially at the same time.

FIG. 10B illustrates an example of a block diagram of the battery pack 1415 illustrated in FIG. 10A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (high-voltage systems HV), and the second battery 1311 supplies electric power to in-vehicle parts for 14 V (low-voltage systems LV). Lead storage batteries are usually used for the second battery 1311 due to cost advantage. Lead storage batteries have disadvantages compared with lithium-ion batteries in that they have a larger amount of self-discharge and are more likely to deteriorate owing to a phenomenon called sulfation. There is an advantage that the second battery 1311 can be maintenance-free when a lithium-ion battery is used; however, in the case of long-term use, for example three years or more, anomaly that is difficult to determine at the time of fabrication might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a secondary battery used, so that fast charging can be performed.

Although not illustrated, in the case of connecting an electric vehicle to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. The plug of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed with electric power supplied from external charging equipment by a contactless power feeding method or the like.

For fast charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, the above-described secondary battery in this embodiment, which is lightweight owing to the use of the separator-integrated electrode described in Embodiment 1 as the negative electrode, can be provided as an in-vehicle secondary battery.

Next, examples in which the secondary battery of one embodiment of the present invention is mounted on a vehicle, typically a transport vehicle, will be described.

Mounting the secondary battery illustrated in any of FIG. 4D, FIG. 6C, and FIG. 10A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

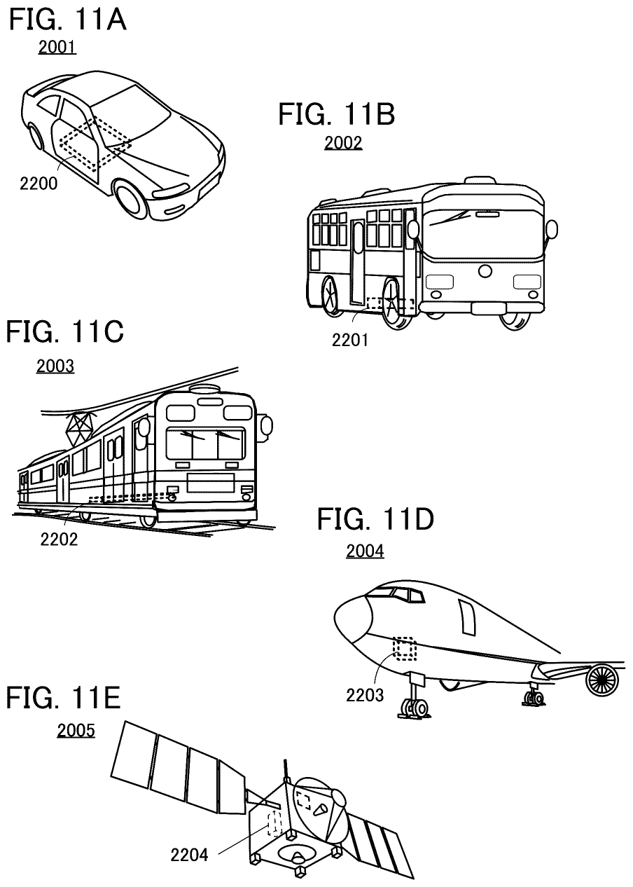

FIG. 11A to FIG. 11D illustrate examples of transport vehicles using one embodiment of the present invention. An automobile 2001 illustrated in FIG. 11A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, a secondary battery exemplified in Embodiment 4 is provided at one position or several positions. The automobile 2001 illustrated in FIG. 11A includes a battery pack 2200, and the battery pack includes a secondary battery module in which a plurality of secondary batteries are connected to each other. Moreover, the battery pack preferably includes a charging control device that is electrically connected to the secondary battery module.

The automobile 2001 can be charged when the secondary battery included in the automobile 2001 is supplied with electric power from external charging equipment by a plug-in system, a contactless power feeding system, or the like. In charging, a given method such as CHAdeMO (registered trademark) or Combined Charging System can be employed as a charge method, the standard of a connector, or the like as appropriate. Charging equipment may be a charge station provided in a commerce facility or a power source in a house. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charging can be performed not only when the vehicle stops but also when moves. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 11B illustrates a large transporter 2002 having a motor controlled by electricity as an example of a transport vehicle. A secondary battery module of the transporter 2002 has a cell unit of four secondary batteries with a nominal voltage of 3.0 V or higher and 5.0 V or lower, and 48 cells are connected in series to have a maximum voltage of 170 V, for example. A battery pack 2201 has the same function as the battery pack in FIG. 11A except, for example, the number of secondary batteries configuring the secondary battery module; thus, the description is omitted.

FIG. 11C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and has a maximum voltage of 600 V, for example. Thus, the secondary batteries are required to have a small variation in performance. The secondary battery that is lightweight owing to the use of the separator-integrated electrode described in Embodiment 1 as the negative electrode can be provided as an in-vehicle secondary battery.

FIG. 11D illustrates an aircraft 2004 having a combustion engine as an example. The aircraft 2004 illustrated in FIG. 11D can be regarded as a kind of transport vehicles since it is provided with wheels for takeoff and landing, and includes a battery pack 2203 that includes a charging control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 11A except, for example, the number of secondary batteries configuring the secondary battery module; thus, the description is omitted.

FIG. 11E illustrates an artificial satellite 2005 including a secondary battery 2204 as an example. Since the artificial satellite 2005 is used in an ultra-low-temperature cosmic space, the secondary battery 2204 having excellent low-temperature resistance of one embodiment of the present invention is preferably provided. It is further preferable that the secondary battery 2204 be mounted inside the artificial satellite 2005 while being covered with a heat-retaining member.

This embodiment can be used in combination with the other embodiments.

### Embodiment 4

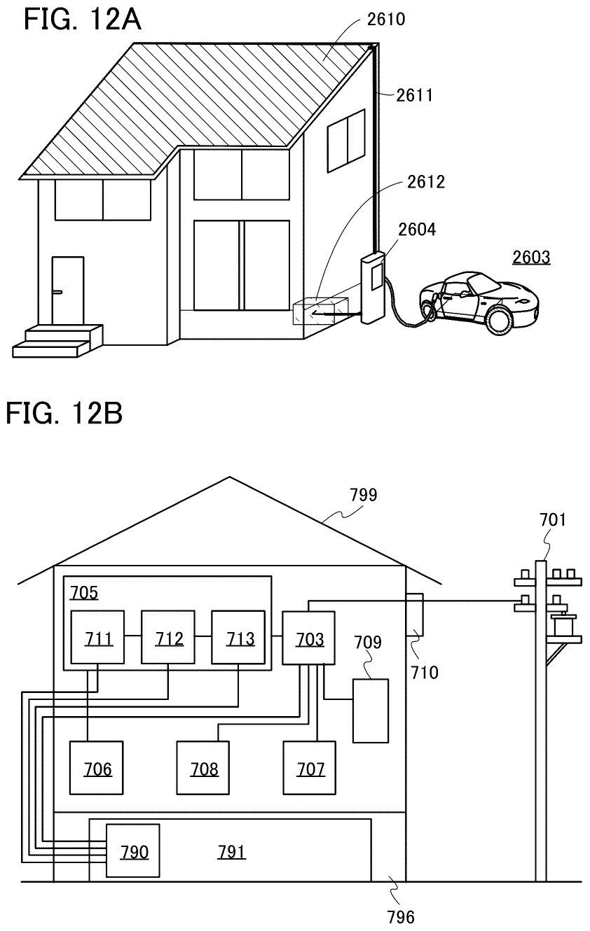

In this embodiment, examples in which the secondary battery of one embodiment of the present invention is mounted on a building will be described with reference to FIG. 12A and FIG. 12B.

A house illustrated in FIG. 12A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source owing to power failure or the like.

FIG. 12B illustrates an example of a power storage device of one embodiment of the present invention. As illustrated in FIG. 12B, a power storage device 791 of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power to be consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electric device such as a TV or a personal computer through the router 709. Furthermore, it can be checked with a portable electronic terminal such as a smartphone or a tablet through the router 709. With the indicator 706, the electric device, or the portable electronic terminal, the demand for electric power depending on a time period (or per hour) that is predicted by the predicting portion 712 can be checked.

This embodiment can be used in combination with the other embodiments.

### Embodiment 5

In this embodiment, examples in which a lithium-ion battery of one embodiment of the present invention is mounted on a motorcycle and a bicycle will be described as examples of mounting a secondary battery in a vehicle.

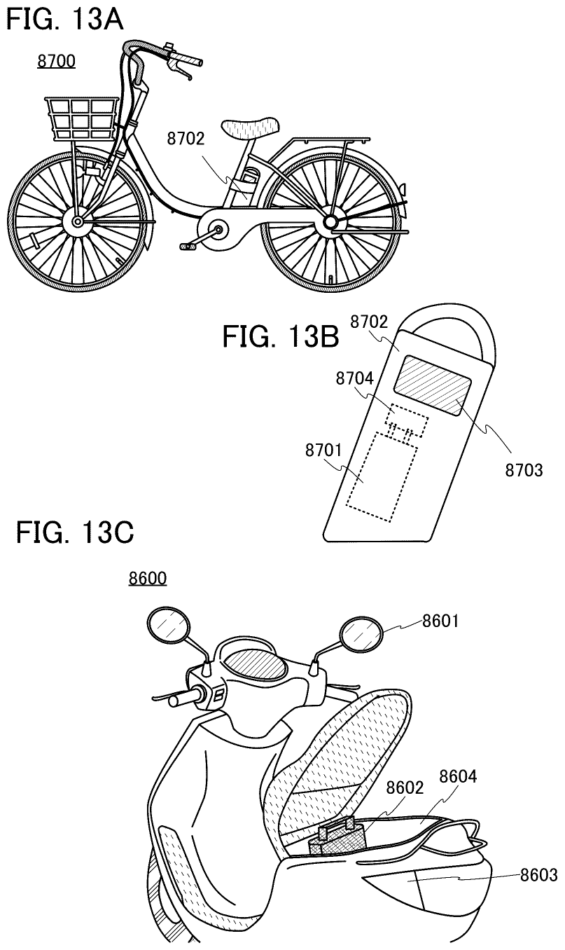

FIG. 13A illustrates an example of an electric bicycle using the power storage device of one embodiment of the present invention. The power storage device of one embodiment of the present invention can be used for an electric bicycle 8700 illustrated in FIG. 13A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 13B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7. The control circuit 8704 is electrically connected to a positive electrode and a negative electrode of the storage battery 8701. A secondary battery that is lightweight by being combined with the secondary battery using the separator-integrated electrode described in Embodiment 1 as the negative electrode can be provided as an in-vehicle secondary battery.

FIG. 13C illustrates an example of a motorcycle using the power storage device of one embodiment of the present invention. A motor scooter 8600 illustrated in FIG. 13C includes a power storage device 8602, side mirrors 8601, and indicator lights 8603. The power storage device 8602 can supply electricity to the indicator lights 8603. A lightweight secondary battery using the separator-integrated electrode described in Embodiment 1 as the negative electrode can be provided as an in-vehicle secondary battery.

In the motor scooter 8600 illustrated in FIG. 13C, the power storage device 8602 can be stored in an under-seat storage unit 8604. The power storage device 8602 can be stored in the under-seat storage unit 8604 even when the under-seat storage unit 8604 is small.

This embodiment can be used in combination with the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

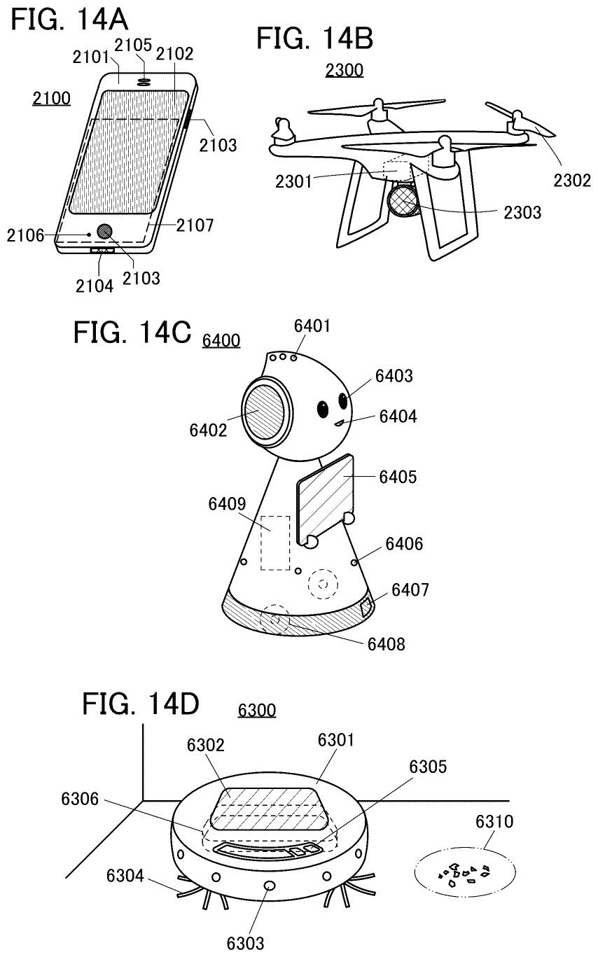

FIG. 14A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. A secondary battery that is lightweight because of including the secondary battery 2107 using the separator-integrated electrode described in Embodiment 1 as the negative electrode can be provided as a secondary battery for small electronic devices.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 14B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery using the separator-integrated electrode described in Embodiment 1 as the negative electrode has a high energy density and is capable of long-duration use over a long period of time, and thus is preferable as the secondary battery included in the unmanned aircraft 2300.

FIG. 14C illustrates an example of a robot. A robot 6400 illustrated in FIG. 14C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. The secondary battery using the separator-integrated electrode described in Embodiments 1, 2, and the like as the negative electrode has a high energy density and is capable of long-duration use over a long period of time, and thus is preferable as the secondary battery 6409 included in the robot 6400.

FIG. 14D illustrates an example of a cleaning robot. A cleaning robot 6300 includes a display portion 6302 placed on the top surface of a housing 6301, a plurality of cameras 6303 placed on a side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304, such as a wire, by image analysis, the rotation of the brush 6304 can be stopped. The cleaning robot 6300 includes, in its inner region, the secondary battery 6306 of one embodiment of the present invention and a semiconductor device or an electronic component. The secondary battery using the separator-integrated electrode described in Embodiments 1, 2, and the like as the negative electrode has a high energy density and is capable of long-duration use over a long period of time, and thus is preferable as the secondary battery 6306 included in the cleaning robot 6300.

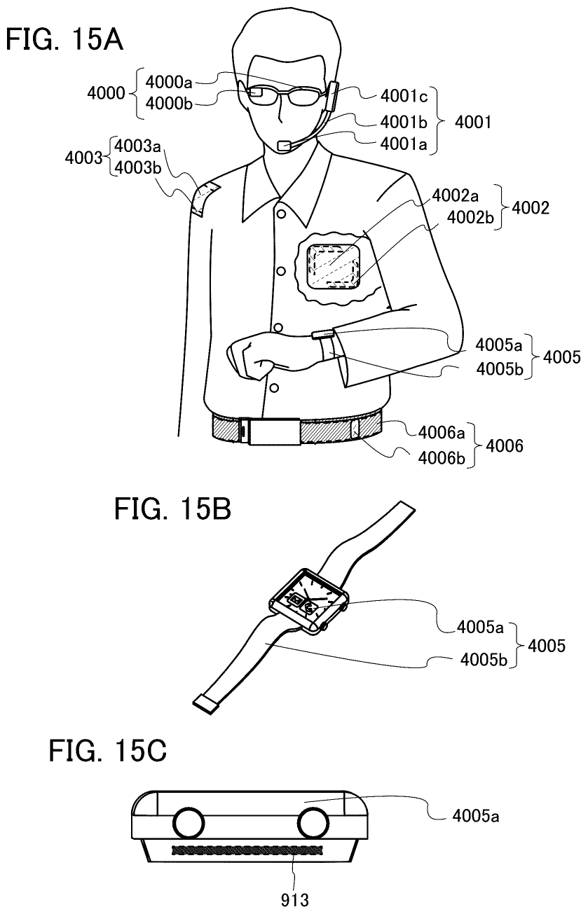

FIG. 15A illustrates examples of wearable devices. A secondary battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be provided in a glasses-type device 4000 illustrated in FIG. 15A. The glasses-type device 4000 includes a frame 4000a and a display portion 4000b. The secondary battery is provided in a temple portion of the frame 4000a having a curved shape, whereby the glasses-type device 4000 can be lightweight, have a well-balanced weight, and be used continuously for a long time. The secondary battery using the separator-integrated electrode described in Embodiments 1, 2, and the like as the negative electrode has a high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. The secondary battery using the separator-integrated electrode described in Embodiments 1, 2, and the like as the negative electrode has a high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. The secondary battery using the separator-integrated electrode described in Embodiments 1, 2, and the like as the negative electrode has a high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. The secondary battery using the separator-integrated electrode described in Embodiments 1, 2, and the like as the negative electrode has a high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. The secondary battery using the separator-integrated electrode described in Embodiments 1, 2, and the like as the negative electrode has a high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. The secondary battery using the separator-integrated electrode described in Embodiments 1, 2, and the like as the negative electrode has a high energy density and achieves a structure that accommodates space saving due to a reduction in size of the housing.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 15B is a perspective view of the watch-type device 4005 that is detached from an arm.

FIG. 15C is a side view. FIG. 15C illustrates a state where the secondary battery 913 is incorporated in the inner region. The secondary battery 913 is the secondary battery described in Embodiment 4. The secondary battery 913 is provided at a position overlapped by the display portion 4005a, can have a high density and high capacity, and is small and lightweight.

Since the secondary battery in the watch-type device 4005 is required to be small and lightweight, the use of the separator-integrated electrode described in Embodiments 1, 2, and the like as the negative electrode enables the secondary battery 913 to have a high energy density and be lightweight.

This embodiment can be used in combination with the other embodiments.

### Example

In this example, a separator-integrated electrode of one embodiment of the present invention was formed, and the strength of the electrode as well as its charge and discharge performance was evaluated.

### <Manufacture of Electrodes>

An electrode 1, an electrode 2, and an electrode 3 each of which is the separator-integrated electrode of one embodiment of the present invention were manufactured by referring to the manufacturing method described in Embodiment 1. A comparative electrode 1 and a comparative electrode 2 were manufactured by a similar manufacturing method.

### [Preparation of Separator]

For manufacture of the electrode 1, the electrode 2, the electrode 3, the comparative electrode 1, and the comparative electrode 2, a separator was prepared first. As the separator, a 25-μm-thick PP (polypropylene) separator was used.

### [Formation of Silicon Layer]

Next, the above separator was fixed to a substrate and transferred into a sputtering deposition apparatus, and a silicon film was formed. The silicon film was formed using a 5N silicon (boron-doped) target with a diameter of 101.6 mm under the conditions of argon at 40 sccm, a pressure of 0.4 Pa, and a power of 500 W (DC). In a sample 1, the silicon film over the separator was formed to have a thickness of approximately 50 nm.

Moreover, a sample 2, a sample 3, a comparative sample 1, and a comparative sample 2 each including the silicon film with a thickness different from that in the sample 1 were manufactured. In the sample 2, the silicon film over the separator was formed to have a thickness of approximately 100 nm. In the sample 3, the silicon film over the separator was formed to have a thickness of approximately 200 nm. As the comparative sample 1, a sample in which the silicon film over the separator was formed to have a thickness of approximately 10 nm was prepared. As the comparative sample 2, a sample in which the silicon film over the separator was formed to have a thickness of approximately 20 nm was prepared.

### [Formation of Carbon Particle Layer]

Then, in each of the sample 1, the sample 2, the sample 3, the comparative sample 1, and the comparative sample 2, a carbon particle layer (graphite layer) was formed over the silicon layer. The carbon particle layer was formed by a blade coating method.

Slurry used for the application of the carbon particle layer was formed by mixing graphite, AB (acetylene black), and PVdF (polyvinylidene fluoride) to have a weight ratio of 95:2:3 with the use of NMP (N-methyl-pyrrolidone) as a dispersion medium. The coating was performed with a blade gap adjusted so that the loading amount of the carbon particle layer was approximately 10 mg/cm². For drying of the dispersion medium after the coating, drying treatment was performed with a ventilation dryer at 50 °C for 3 hours. The formation conditions of the carbon particle layer were the same for all the samples.

By the above-described method, the carbon particle layer was provided in each of the sample 1, the sample 2, the sample 3, the comparative sample 1, and the comparative sample 2. The sample 1 after the carbon particle layer is provided is referred to as the electrode 1, the sample 2 after the carbon particle layer is provided is referred to as the electrode 2, the sample 3 after the carbon particle layer is provided is referred to as the electrode 3, the comparative sample 1 after the carbon particle layer is provided is referred to as the comparative electrode 1, and the comparative sample 2 after the carbon particle layer is provided is referred to as the comparative electrode 2.

### [Strength of Separator-Integrated Electrode]

Next, the punching strength of the electrode 1, the electrode 2, the electrode 3, the comparative electrode 1, and the comparative electrode 2 was examined. Table 1 shows the results of punching a 12-mm-diameter circle in each of the electrode 1, the electrode 2, the electrode 3, the comparative electrode 1, and the comparative electrode 2. Note that the comparative electrode 1 was not subjected to the punching because the entire carbon particle layer had peeled off before the punching.

TABLE 1

| | Electrode name | | | | |
|---|---|---|---|---|---|
| | Elec- | Elec- | Elec- | Comparative | Comparative |
| | trode 1 | trode 2 | trode 3 | electrode 1 | electrode 2 |
| Thickness | 50 nm | 100 nm | 200 nm | 10 nm | 20 nm |
| of silicon | | | | | |
| layer | | | | | |
| Results of | Slight | Favorable | Favorable | Entire layer | Large film |
| punching | film | | | peeled off | peeling |
| | peeling | | | before | |
| | | | | punching | |

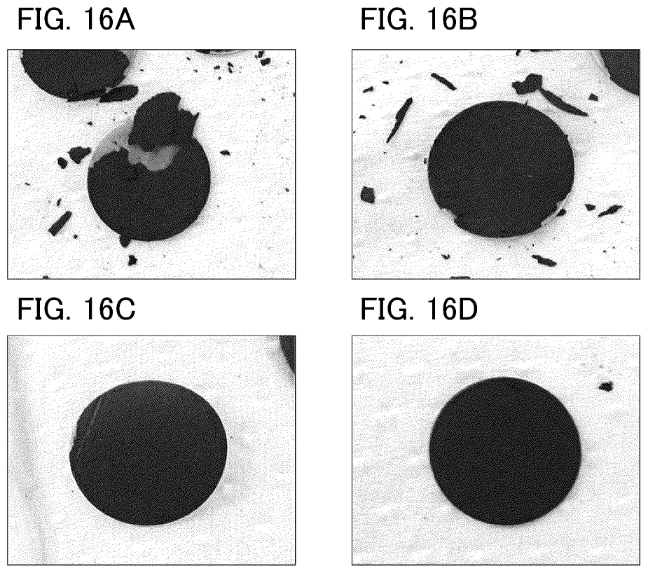

FIG. 16A, FIG. 16B, FIG. 16C, and FIG. 16D show photographs after the circular punching. FIG. 16A is a photograph of the comparative electrode 2 (the 20-nm silicon layer) after the punching, FIG. 16B is a photograph of the electrode 1 (the 50-nm silicon layer) after the punching, FIG. 16C is a photograph of the electrode 2 (the 100-nm silicon layer) after the punching, and FIG. 16D is a photograph of the electrode 3 (the 200-nm silicon layer) after the punching.

As shown in Table 1 and FIG. 16, in the case where the thickness of the silicon layer is greater than or equal to 20 nm, a separator-integrated electrode in which the separator and the carbon particle layer are integrated with each other was obtained. In the case where the thickness of the silicon layer is greater than or equal to 50 nm, peeling of the carbon particle layer was significantly reduced. In the case where the thickness of the silicon layer is greater than or equal to 100 nm, a favorable separator-integrated electrode with almost no peeling of the carbon particle layer was obtained.

Here, the separator-integrated electrode punched from the electrode 1 is referred to as an electrode 1A. The separator-integrated electrode punched from the electrode 2 is referred to as an electrode 2A. The separator-integrated electrode punched from the electrode 3 is referred to as an electrode 3A. The separator-integrated electrode punched from the comparative electrode 2 is referred to as a comparative electrode 2A.

### [Formation of Half-Cell]

Next, CR2032 coin-type batteries (a diameter of 20 mm, a height of 3.2 mm) were manufactured using the electrode 1A, the electrode 2A, the electrode 3A, and the comparative electrode 2A as positive electrodes.

Lithium metal foil was used for counter electrodes (negative electrodes of the coin-type batteries). A glass fiber sheet (a thickness of 260 μm, a hole diameter of 1.2 μm) was provided between the counter electrodes and the above-described electrodes (the electrode 1A, the electrode 2A, the electrode 3A, and the comparative electrode 2A).

As an electrolyte contained in an electrolyte solution, 1 mol/L of lithium hexafluorophosphate (LiPF₆) was used. As the electrolyte solution, a solution in which ethylene carbonate (EC) and diethyl carbonate (DEC) were mixed at EC:DEC=3:7 (volume ratio) was used.

A positive electrode can and a negative electrode can that were formed of stainless steel (SUS) were used.

Here, the coin-type battery fabricated using the electrode 1A is referred to as a cell 1. The coin-type battery fabricated using the electrode 2A is referred to as a cell 2. The coin-type battery fabricated using the electrode 3A is referred to as a cell 3. The coin-type battery fabricated using the comparative electrode 2A is referred to as a comparative cell 2.

### [Charge and Discharge Performance]

The charge and discharge performance of the cell 1, the cell 2, the cell 3, and the comparative cell 2 that were fabricated above was examined. Measurement of the charge and discharge performance started with discharge. CCCV (constant current constant voltage) discharge at 0.2 C, 0.01 V, and a cutoff current of 0.02 C was performed. Next, CC (constant current) charge at 0.2 C and a cutoff voltage of 1.0 V was performed. Note that here, 1 C was set to 0.035 mA/g as a current value per weight of graphite. The measurement temperature was 25 °C.

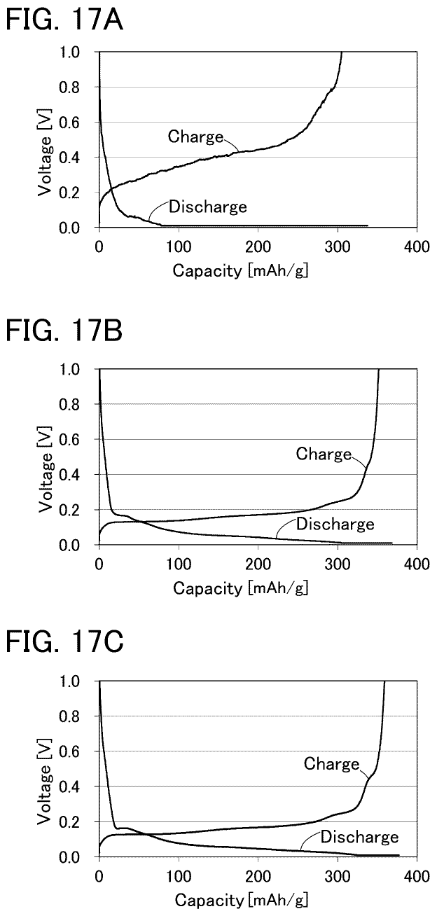

FIG. 17A to FIG. 17C show the measurement results of the charge and discharge performance of the cell 1, the cell 2, and the cell 3. Note that the comparative cell 2 is not shown because the comparative cell 2 was hardly charged and discharged under the above-described charge and discharge conditions.

FIG. 17A is a graph showing the charge and discharge results of the cell 1 (the 50-nm silicon layer), demonstrating that the cell 1 was capable of being charged and discharged. FIG. 17B is a graph showing the charge and discharge results of the cell 2 (the 100-nm silicon layer), demonstrating that the cell 2 was capable of being charged and discharged. FIG. 17C is a graph showing the charge and discharge results of the cell 3 (the 200-nm silicon layer), demonstrating that the cell 3 was capable of being charged and discharged.

When comparing the charge and discharge performance of the cell 1, the cell 2, and the cell 3, the discharge curve of the cell 1 was on the lower voltage side than those of the cell 2 and the cell 3. The charge curve of the cell 1 was on the higher voltage side than those of the cell 2 and the cell 3. That is, the internal resistance (also referred to as reactive resistance) of the cell 1 is probably higher than the internal resistances of the cell 2 and the cell 3.

As described above in this example, it was found that the battery including the separator-integrated electrode manufactured by the manufacturing method described in Embodiment 1 can be charged and discharged when the thickness of the silicon layer is greater than or equal to 50 nm. That is, with the use of the separator-integrated electrode not including metal foil as a current collector, which is described in Embodiment 1, a lightweight battery capable of being charged and discharged was fabricated.

It was also found that the cell 2, which includes the 100-nm-thick silicon layer, and the cell 3, which includes the 200-nm-thick silicon layer, each have low internal resistance and can perform favorable charge operation and discharge operation. Thus, in the separator-integrated electrode of one embodiment of the present invention, the thickness of the silicon layer is desirably greater than or equal to 100 nm and less than or equal to 200 nm.

### REFERENCE NUMERALS

10: coin-type battery, 11: separator, 12: separator, 13: binder, 14: conductive material, 20: positive electrode, 21: positive electrode current collector, 22: positive electrode active material layer, 31a: silicon layer, 31: silicon layer, 32: carbon particle layer, 33: carbon particle, 34: metal layer, 35: lead, 40: separator-integrated electrode, 51: positive electrode can, 52: negative electrode can, 53: gasket

1. A battery comprising:
a separator-integrated electrode,
wherein the separator-integrated electrode comprises a separator, a carbon particle layer, and a silicon layer positioned between the separator and the carbon particle layer.

2. A battery comprising:
a separator-integrated electrode and an exterior body,
wherein the separator-integrated electrode comprises a separator, a carbon particle layer, and a silicon layer positioned between the separator and the carbon particle layer, and
wherein the carbon particle layer and the exterior body comprise a region where they are in contact with each other.

3. The battery according to claim 1,
wherein a thickness of the silicon layer is greater than or equal to 100 nm and less than or equal to 200 nm.

4. The battery according to claim 1,
wherein the separator comprises polypropylene.

5. A method for manufacturing a battery comprising a separator-integrated electrode comprising a separator, a carbon particle layer, and a silicon layer positioned between the separator and the carbon particle layer, the method comprising:
a first step of forming the silicon layer over the separator by a sputtering method; and
a second step of forming the carbon particle layer over the silicon layer by application of slurry comprising carbon particles,
wherein a thickness of the silicon layer is greater than or equal to 100 nm and less than or equal to 200 nm.

6. The method for manufacturing a battery, according to claim 5,
wherein the slurry comprises N-methyl-pyrrolidone.

7. The method for manufacturing a battery, according to claim 5,
wherein the separator comprises polypropylene.
